(19) United States
(12) Patent Application Publication
(10) Pub. No.: US 2024/0247718 A1
(43) Pub. Date: Jul. 25, 2024

(54) GEARSHIFT WITH MOVING MAGNET ACTUATOR

(71) Applicant: TECHNISCHE UNIVERSITÄT DARMSTADT, Darmstadt (DE)

(72) Inventors: Daniel Schöneberger, Darmstadt (DE); Oliver Hahn, Darmstadt (DE); Daniel Franz, Darmstadt (DE)

(21) Appl. No.: 18/561,335

(22) PCT Filed: May 19, 2022
(86) PCT No.: PCT/EP2022/063634

§ 371 Date: Nov. 16, 2023

(30) Foreign Application Priority Data
May 19, 2021 (DE) 10 2021 113 012.3

(51) Int. Cl. F16H 63/38; F16H 63/30

(52) U.S. Cl. CPC F16H 63/38; F16H 2063/305; F16H 2200/0021

(57) ABSTRACT

A gearshift for an electric drive includes a housing having a depressed portion with an opening through which a movable component is led. Further, the gearshift for the electric drive includes at least one moving magnet actuator. The at least one moving magnet actuator is configured to move the component and mounted in the depressed portion.

### PRIORITY CLAIM

The present application is a National Phase entry of PCT Application No. PCT/EP2022/063634, filed May 19, 2022, which claims priority from German Patent Application No. 10 2021 113 012.3, filed May 19, 2021, the disclosures of which are hereby incorporated by reference herein in their entirety.

### FIELD OF THE INVENTION

The present invention relates to a gearshift of an electric drive, a moving magnet actuator, a control unit for an activation of at least two moving magnet actuators, a method for mounting and a method for dismounting a moving magnet actuator and, in particular, to a double coil and sequential switching electronics for a moving magnet actuator in electrified vehicle drives.

### BACKGROUND

Moving magnet actuators are linear actuators in which a plunger is moved linearly, along an axis of the plunger, by means of an electric current via Lorentz forces. The basic concept is that of a plunger coil, i.e. a coil wound from a wire for conducting an electric current, which is located in a magnetic field of a permanent magnet, so that when a current is fed to the coil, a force is built up which displaces the coil relative to the permanent magnet in an axial direction. In such a device, it may be that either the permanent magnet is fixed on the plunger and the coil is part of the stator, or that the coil is wound around the axis of the plunger and the permanent magnet is part of the stator. Moving magnet actuators are used in various implementations in many areas of mechanical engineering for linear movements, some of which are highly dynamic.

In particular, moving magnet actuators are used to change gears in electric drives. Such electric drives can be used in automobiles, for example, and require appropriately secure gearshifts. For this purpose, such gearshifts comprise components such as, in particular, shift rods, which must be moved linearly with great precision and fine tuning. Moving magnet actuators can perform such movements with the required precision and control.

FIG. 16 shows an example in the prior art for a moving magnet actuator 410 in a gearshift 430 for changing gears of an electric drive. Shown in cross-section are parts of a housing 431 of the gearshift 430, wherein the housing in particular has an opening through which a shift rod 432 is guided for moving a shift fork 434. The moving magnet actuator 410 comprises two coils 4131, 4132 in a cylindrical outer hull 414. A portion 411 of the shift rod 432 dips into a portion of the coils 4131, 4132 such that the shift rod 432 itself forms the plunger of the moving magnet actuator 410. The portion 411 of the shift rod 432 is fixedly connected to a permanent magnet 412 and is movably supported together therewith within the coils 4131, 4132. When a current feed is applied to the coils 4131, 4132, a magnetic field is formed which exerts a force on the permanent magnet 412, thereby moving the shift rod 432.

FIG. 17 shows a view of the hull 414 of the moving magnet actuator 410. The hull 414 has a flange 415 for screws, by which the moving magnet actuator 410 is fastened to the housing 431 with screws 416. In this example, the restricted spatial conditions of the gearshift 430 mean that for geometric reasons, the flange 415 cannot simply be round, but must have a contour as shown. The restricted spatial conditions often lead to restrictive requirements in terms of shape and dimensions for components, particularly in automotive drive devices, which complicate and increase the cost of manufacturing the components in each case.

FIG. 18 shows further details for the electric drive to illustrate the task of the moving magnet actuator 410. For this purpose, a topology of the electric drive is sketched in a left side of the figure. This topology shows two electric motors 501, 502, each driving a sub-transmission 510, 520. The sub-transmissions 510, 520 are connected to each other via a differential gear 530, which transmits forces from the electric motors 510, 520 to wheel axles 540 of an electric car. In particular, a sub-transmission 520 includes a shifting mechanism 550 that comprises a claw clutch 555 as shown in a right side of the figure. The shifting mechanism 550, or a portion of the claw clutch 555, is moved by the shift fork 434 (see FIG. 16), such that the electric drive provides a total of three gears. The structure of the transmission with the two non-identical sub-transmissions 510, 520 allows a desired power to be divided between the electric motors 501, 502. This can optimize an efficiency and vibration behavior of the entire drive train.

For gear shifting devices in which a plurality of moving magnet actuators perform movements of components in strict sequence, the ensuring of the sequential execution is of great importance. An example of an apparatus for sequential execution of actuator movements can be taken from document DE10 2015 226 351, which discloses a system comprising a plurality of actuators connected to each other and to a higher-level electronic control device via data lines. The system is configured to activate the actuators in a plurality of patterns. In this regard, each actuator is associated with its own control unit configured to send and receive data through the data lines and to activate the respective associated actuator based on the data.

In examples in the prior art, control units for each moving magnet actuator may comprise a microcontroller that activates the respective moving magnet actuator via a full bridge circuit.

A disadvantage of this solution is the complicated or redundant design of the control system, especially due to the use of individual control units for each actuator. In the confined spaces of vehicle drives, for example, this design can be difficult to implement. In addition, there can be an increased potential for failures.

When a moving magnet actuator is mounted in a holder, reluctance forces can occur between the moving magnet actuator and parts of the gearshift. For example, during mounting of the moving magnet actuator 410 shown in FIG. 13, such reluctance forces occur in particular between the hull 414 with the coils 4131, 4132 and the permanent magnet 412. The reluctance forces make it necessary to guide the moving magnet actuator or its hull during mounting.

If a component—such as a shift rod—is moved by a moving magnet actuator in a gearshift, the component usually has to be securely held in certain positions—which may correspond to certain gears of the drive device, for example. For this purpose, there are in particular mechanical locking devices in the prior art.

FIG. 19 shows on the left a conventional system for locking a shift sleeve 436 arranged on a shaft, which is combined with a locking mechanism 440 for the shift rod 432 or shift fork 434. The figure shows on the right a more detailed representation of the locking mechanism 440 for the shift rod 432. In this mechanical locking mechanism, a ball spring unit 442 running over a contour ensures that a force effect counteracts a deflection and thus the shift rod 432 and thereby the shift fork 434 are held in position with a certain force (locking force). The positions may correspond e.g. to a first gear, a neutral position, and a second gear. The locking mechanism causes costs for gearshift manufacturers due to the procurement of components and processing steps in the gearshift.

In the context of the development of electric drives, there is in general a need for moving magnet actuators and for switching electronics that offer the most cost-effective, uncomplicated and space-saving solutions with the least possible effort in the areas of manufacturing, mounting, operation and dismounting.

### SUMMARY OF THE INVENTION

A contribution to this objective is made by a gearshift according to claim 1, a method of mounting a moving magnet actuator according to claim 11, a method of dismounting a moving magnet actuator according to claim 13, a method of sequentially activating at least two moving magnet actuators according to claim 14, a method of winding a wire into a coil according to claim 15, a method of manufacturing a moving magnet actuator according to claim 16, and a machine-readable storage medium according to claim 17. The dependent claims relate to advantageous embodiments of the independent claims.

The present invention relates to a moving magnet actuator having a plunger, a magnet component and a coil. The coil has a plurality of coil sections along an axis, which may be in particular parallel to an axis of the plunger. The coil is formed by a wire which, starting from a first end of the coil and extending successively to a second end of the coil, forms for each coil section a first winding in a respective winding direction associated with a coil section. There is at least one change in winding direction between a first coil section and a subsequent second coil section, so that when a current feed is applied to the wire, each coil section amplifies a force on the magnet component to cause linear movement of the plunger. Further, the wire forms a second winding from the second end of the coil to the first end of the coil successively for each coil section in the winding direction associated with the respective coil section. The wire thus both enters and exits the coil at the first end of the coil.

Here, the term winding is to be understood as a spiral arrangement of the wire in at least one layer. In an advantageous embodiment, the first winding comprises only one layer, while the second winding comprises an equal, larger number of layers in each of the coil sections. An arrangement of the layers can be selected according to need and requirement such that, for example, an orthocyclic winding, a helical winding or even a wild winding is present. In addition, a number of windings in each coil section and in each layer can be adapted to geometrical boundary conditions, in particular, for example, to a shape or size of the magnet component or the plunger, and/or to operating conditions, such as the expected current strengths or the desired forces.

Advantages of the winding of the coil presented here lie in particular in a reduced volume. For example, one advantage is that only a single wire is sufficient for the winding of all coil sections, and a separate wire does not have to be used for each coil section. This reduces the number of connections for the current feed to the moving magnet actuator. At the same time, there is an advantage from the wire entering and exiting on the same side of the coil, since in this way it is possible to lead the wire out of the moving magnet actuator, or to connect the coil to a current source, without having to lead the wire back along a path that would not contribute to the magnetic field of the coil.

In an advantageous embodiment, the magnet component forms a dipole magnetic field with a north magnetic pole and a south magnetic pole along the axis. The coil comprises two coil sections with opposite winding directions, so that due to the opposite winding directions of the coil sections, a current flowing through the coil generates, in both coil sections, a force acting in the same direction on the magnet component, or thereby on the plunger. The Lorentz force in both coils then acts in the same direction. When the current flow is reversed, the effect on the magnet component and thus the force on the plunger is reversed.

In embodiments in which the coil of the moving magnet actuator comprises only two coil sections, the coil may alternatively be described as comprising a first coil section having a first winding about the axial axis and a third winding about the axial axis, and a second coil section having an oppositely directed second winding about the axial axis. In this regard, the second coil section is arranged adjacent to the first coil section with respect to the axial axis (at a certain distance). The oppositely directed second winding is connected in series between the first winding and the third winding, so that an electric current reverses its direction of rotation twice when the first, second and third windings are energized. The plunger couples to the magnet component or to one of the coil sections to cause the movement when current is fed.

Optionally, the magnet component is fixedly connected to the plunger, and the coil is thus part of a stator. In particular, the magnet component may have a hollow cylindrical shape that lies around the plunger. Alternatively, the coil may be wound around the plunger and the magnet component may be formed as part of the stator, for example in the form of a tube or cylindrical shell.

Optionally, the moving magnet actuator further comprises an advantageously cylindrical outer hull having on an outer side a circumferential groove for applying a shaft locking ring and/or a circumferential sealing element and/or a common inlet and outlet of the wire for current feed to the coil.

A shaft locking ring, or grooved ring, can advantageously be used to guide the moving magnet actuator during mounting or dismounting in an apparatus, such as in a depressed portion of a housing of a gearshift for an electric drive. The circumferential scaling element may in particular be an O-ring. The O-ring may be fitted in a further groove, for example parallel to the groove for the shaft locking ring, on the outside of the outer hull. The common inlet and outlet of the wire or of the connection of the coil to the current feed utilizes the advantage granted by the exit of the wire on the same side of the coil. In particular, the wire can thus be energized very easily on one side of the moving magnet actuator (for example, an end face).

Embodiments further relate to a control unit for activation of at least two actuators. The actuators may be moving magnet actuators of the form mentioned above. For each actuator, the control unit comprises an electronic switch or switch terminal, which may in particular comprise a metal-oxide semiconductor field-effect transistor (MOSFET) and is designed for activating and deactivating the respective actuator or, in the event of a current feed, permits activation of the respective actuator in a first state and prevents activation in a second state. Further, the control unit comprises a bridge circuit component, for example a full bridge or a four-quadrant controller, in which at a load position the electronic switches, or MOSFET switches, are switched in such a way that a current at the load position is divided between the electronic switches. The bridge circuit is configured to be connected to a supply voltage and to provide a parallel current feed to the electronic switches when connected to the supply voltage. In particular, the at least two actuators may be arranged in parallel on a bridge branch of a full bridge. The control unit further comprises an electronic control unit, which may in particular comprise a microcontroller and which comprises a connection component with a connection to each of the electronic switches. The control unit is configured to control the parallel current feed via the bridge circuit component, and also to set each of the electronic switches individually to the first state or the second state via the connection component. The connection component may, for example, comprise a respective line from a suitable port of the electronic control unit to a gate terminal of one of the electronic switches.

Advantageously, a constant current feed to each actuator is not necessary for the use of this control unit. In embodiments, the circuit is used in particular for moving magnet actuators for shift rods of a gearshift, which is configured to reliably lock or hold the shift rods in a selected shift position.

Optionally, the connection component comprises a safety circuit having exactly one AND gate and one NOR gate for each actuator and otherwise no gates, and is configured to allow activation of at most one actuator at any time.

For several moving magnet actuators for shifting gears in a transmission, it is usually of great importance that the moving magnet actuators are sequentially activated. The safety circuit offers the advantage of ensuring sequential activation in a simple and space-saving way, independent of software or programming of the electronic control unit.

Embodiments further refer to a gearshift or to an apparatus for changing gears, in particular of an electric drive. The gearshift comprises a housing having a depressed portion with an opening through which a movable component, in particular for example a shift rod, is led for changing the gears. Further, the gearshift comprises an actuator, in particular a moving magnet actuator, configured to move the component and mounted in the depressed portion, in particular by an interference fit. The actuator may be mounted by the interference fit in the depressed portion or in a widened portion of the opening, or in an area of the housing where the component passes through a wall of the housing. The interference fit offers the advantage of dispensing with a screw connection of the actuator. In embodiments with a moving coil actuator, the shift rod can be identical to the plunger of the moving coil actuator. The moving magnet actuator does not necessarily have to have the coil winding described above.

Optionally, however, the gearshift actuator is a moving magnet actuator as described above. In particular, therefore, the coil may have the structure and coil winding described above, and an outer hull of the moving magnet actuator may be provided with a groove for applying a shaft locking ring to facilitate mounting or dismounting, and with a sealing element.

Optionally, the gearshift also comprises at least two actuators and a control unit of the type described above.

Embodiments further relate to a method of winding a wire into a coil for a moving magnet actuator. The method comprises the steps of:
forming a first winding, starting from a first end of the coil, for a plurality of coil sections in a winding direction associated with each coil section, such that there is at least one change in winding direction between a first coil section and a subsequent second coil section; and
forming a second winding, starting from a second end of the coil, for each coil section, in the winding direction associated with the respective coil section so that the wire exits the coil at the first end of the coil.

The coil may be either part of the stator or part of the plunger of the moving magnet actuator. In embodiments, the coil is part of the stator, and the plunger comprises a permanent magnet forming a dipole magnetic field similar to that of a bar magnet, with poles on an axis of the plunger. Advantageously, the coil then has two coil sections. The first winding may comprise only one layer. Other geometries are conceivable; in particular, the design of the preceding embodiment can be multiplied to several permanent magnets and correspondingly several coil sections.

Embodiments also relate to a method of mounting an actuator, in particular a moving magnet actuator, in a depressed portion of a housing of an apparatus, in particular a gearshift of an electric drive. The method is characterized by the steps:
clamping at least a portion of the actuator and of the housing; and
pressing the clamped portion of the actuator into the depressed portion of the housing, thereby mounting the actuator in the depressed portion.

For secure and fast mounting of the actuator, the actuator can be guided radially and held axially, so that the actuator is advantageously not pulled out of its guide either by its weight force or by a reluctance force (for example caused by a magnetic device). In an automated manufacturing process, rigid fixing of the actuator can be achieved by the axial pressing.

In embodiments of this method, a moving magnet actuator is mounted by pressing a stator of the moving magnet actuator, or a portion of the moving magnet actuator comprising the hull and the coil, into a depression of a gear housing by means of an interference fit, so that a movable component guided through an opening in the depression of the gear housing constitutes a plunger of the moving magnet actuator. This press fit then absorbs axial forces occurring during gear shifting. The moving magnet actuator does not necessarily have to have the coil winding described above. The actuator hull can be a simple rotating part.

Optionally, in cases where the actuator or moving magnet actuator has an outer hull with a preferably circumferential groove as described above, clamping the actuator or moving magnet actuator may comprise setting it into a mounting device formed with a latch that can engage the groove. Clamping then further comprises securing the actuator or moving magnet actuator by the latch, so that the actuator or moving magnet actuator cannot fall out. Pressing may then comprise exerting a press-in force on the mounting device so as to mount the actuator in the housing. Advantageously, the press-in force is higher than a force capable of loosening the actuator or moving magnet actuator from its seat in the housing.

The mounting device can, for example, be configured pot-shaped to at least partially accommodate the actuator or moving magnet actuator. Press-in can then take place by applying the press-in force to a base of the mounting device, for example. In this way, the press-in force can be transmitted directly to the actuator or moving magnet actuator. Once the actuator or moving magnet actuator has been pressed into the housing, the latch can be loosened again by pulling, and the mounting device can be lifted off the actuator or moving magnet actuator.

The mounting device can be mounted on any linear pressing tools. For example, a simple manual press can be used for this purpose. However, hydraulic or pneumatic presses in automated or collaborative production lines, such as those commonly used in gear manufacturing, are also possible. The mounting device can also be fitted with the actuator or moving magnet actuator manually or automatically, e.g. by a robot.

Overall, mounting using this method completely eliminates the need for screwing. The number of work steps can thus be significantly reduced compared to screwing. The method thus enables external mounting of a moving coil actuator in a depressed portion around an opening in a housing, through which a component to be moved by the moving coil actuator is led. The component may be rigidly connected to or identical with the plunger of the moving magnet actuator.

Advantageously, the hull of the actuator may have a sealing element on an outer side, in particular such as an O-ring, which seals against air and/or moisture penetrating the housing.

Embodiments further relate to a method for dismounting an actuator, in particular a moving magnet actuator, which is fixed by means of an interference fit in a depressed portion of a housing of an apparatus, in particular a gearshift of an electric drive. The actuator comprises an advantageously cylindrical outer hull having on an outer side a circumferential groove for fixing a shaft locking ring. The method is characterized by the steps:
applying a ring component having a plurality of threaded holes to the actuator;
securing the ring component on the actuator by means of a fixing of the shaft locking ring in the groove;
inserting a screw into each of the threaded holes so that each screw is propped against the housing at one end;
loosening of the actuator by turning the screws in order to then dismount the actuator from the housing by means of the shaft locking ring.

In embodiments, this method is applied to a moving magnet actuator that is fixed in a depressed portion of a housing of a gearshift for an electric drive by means of an interference fit. The coil of the moving magnet actuator need not necessarily have the winding described above.

The ring component can in particular be a steel ring. In embodiment examples, the ring component has three threaded holes. The shaft locking ring can be mounted using retaining pliers, for example.

Embodiments further relate to a method for sequentially activating at least two actuators. The actuators are each connected to an electronic switch, which may comprise in particular a MOSFET, and the electronic switches are configured to activate or deactivate the respective actuator. The method is characterized by the steps:
parallel current feed of the electronic switches via a bridge circuit;
sequentially admitting the current feed to the actuators via the electronic switches in order to sequentially activate the actuators.

In embodiments, the at least two actuators are each moving magnet actuators. The moving magnet actuators do not necessarily have to have a coil with the winding described above.

Embodiments also relate to a computer program product having software code stored thereon, which, when the software code is executed by a data processing machine, is adapted to have any of the methods described above performed.

Embodiments of the present invention may be summarized as follows. In a moving magnet actuator, instead of two single coils, a double coil is manufactured using a special winding technique that requires a connection only at one end.

A control unit or sequential switching electronics utilizes a full bridge and a microcontroller together with supplemented electrical switches to control or energize several moving magnet actuators sequentially, i.e. one after the other. The control unit offers the advantage that switching electronics for controlling a single moving magnet actuator need not be multiplied. Advantageously, it is a prerequisite that positions of the moving magnet actuators or positions of the components moved by them are held independently, i.e. without current feed to the moving magnet actuators. A logic circuit can be utilized to prevent multiple actuators from being energized simultaneously, which is a safety benefit.

Instead of mounting by means of screws and bolting flange, the hull of the actuator can be pressed into the gear unit or into a housing. For any dismounting that may be necessary, a steel ring with three threads can be placed over the actuator. A shaft locking ring is then placed in a groove provided for this purpose. Three screws are screwed into the ring, which is supported by the shaft locking ring, and the moving magnet actuator can thus be pulled out of the gearbox housing.

Embodiments of the present invention provide the following advantages: Fabrication, mounting and dismounting of a moving magnet actuator for electric drives can be simplified. In addition, the cost, complexity, and installation space of the electronics for multiple moving magnet actuators in a drive device can be reduced. Embodiments of the moving magnet actuator and control unit can be used in a variety of systems that utilize positive switching elements, such as engageable four-wheel drives, differential locks, motorsports transmissions, motorcycle transmissions, machining technology, or valve actuation.

The method for mounting and the method for dismounting reduce production and material costs, and also the installation space required for the switching actuator. The methods can basically be used if a pot-shaped object is to be mounted in an apparatus with the open side facing inward and should be able to be dismounted.

Further embodiments relate to a moving magnet actuator comprising a plunger with a magnet component mounted thereon, and a coil wound around a bobbin. A reluctance component of a ferromagnetic or ferrimagnetic material, such as iron, extending in a circumferential direction, is applied to the bobbin at an axial position. The circumferential direction may be given in particular by an angle in a plane perpendicular to an axis of the moving magnet actuator, of the bobbin, or of a plunger mobility direction. Due to the reluctance component, magnetic resistance is locally reduced at this axial position, and a corresponding reluctance force results on the magnet component and thus on the plunger. In this way, locking of the plunger at an axial locking position is realized. The reluctance force acts on the plunger within a range around the locking position, and as a restoring force towards the locking position. The reluctance force is superimposed on the force exerted on the magnet component or plunger by a current feed to the coil. The axial extent or thickness of the reluctance component is advantageously small compared to the axial extent or length of the moving magnet actuator.

Local differences in the magnetic resistance can also result from the construction of the coil or bobbin, in particular from gaps localized in the axial direction. However, the reluctance component extending in the circumferential direction can cause a much higher reluctance force than such a gap or discontinuity in the bobbin or coil, so that the locking position can be held more securely.

In such embodiments, the moving magnet actuator thus provides a gear lock, albeit not by a Lorentz force, but rather by the reluctance force, which does not require a current feed to the coils.

Optionally, a further reluctance component made of the ferromagnetic or ferrimagnetic material is applied to the bobbin at at least one further axial position. In this case, the reluctance component and the further reluctance component each extend over at least an angle of 180° in the circumferential direction, and they are also arranged offset from one another by 180° in the circumferential direction. The reluctance component and the further reluctance component may thus each have substantially the shape of an arc of a circle. This makes it particularly easy to apply the reluctance components to the bobbin (in particular compared with a design as complete rings).

Thus, in some of these embodiments, the moving magnet actuator comprises a plurality of reluctance components for forming a reluctance force profile along an axis of the moving magnet actuator, wherein some reluctance components are arranged offset or rotated from each other by 180°. It has been found that such arrangements can cancel a radial force on the magnet component. A radial force can occur in particular because the reluctance components are not rotationally symmetrical in the circumferential direction. The cancelation does not have to be complete; forces can still act locally in the radial direction on the magnet component or the plunger.

Optionally, the reluctance components are each fitted or clamped in a groove of the bobbin, or in a bobbin groove, and thus fixed, in particular against axial movements.

Further embodiments relate to a method of manufacturing a moving magnet actuator. The method comprises manufacturing a bobbin having a bobbin groove at an axial position of the bobbin. The method further comprises fitting a reluctance component of a ferromagnetic or ferrimagnetic material into the bobbin groove, wherein the reluctance component extends in a circumferential direction on or about the bobbin after fitting.

### BRIEF DESCRIPTION OF THE DRAWINGS

The embodiments of the present invention will be better understood with reference to the following detailed description and accompanying drawings of the various embodiments, which, however, should not be construed as limiting the disclosure to the specific embodiments, but are for explanation and understanding only.

FIG. 1 illustrates an embodiment of a moving magnet actuator with a coil winding according to the present invention.

FIG. 2 illustrates a winding diagram of a coil in the moving magnet actuator of FIG. 1.

FIG. 3 shows inclusions of an embodiment of the coil.

FIG. 4 illustrates an embodiment of a control unit according to the present invention.

FIG. 5 illustrates an embodiment of the control unit with a safety circuit.

FIG. 6 shows steps of a method according to the present invention for winding a coil for a moving magnet actuator.

FIG. 7 illustrates the method for winding a coil.

FIG. 8 shows steps of a method according to the present invention for mounting a moving magnet actuator.

FIG. 9 illustrates the method for mounting a moving magnet actuator.

FIG. 10 shows steps of a method according to the present invention for dismounting a moving magnet actuator.

FIG. 11 illustrates the method for dismounting the moving magnet actuator.

FIG. 12 shows steps of a method according to the present invention for sequentially activating multiple moving magnet actuators.

FIG. 13 illustrates a reluctance force curve for a moving magnet actuator with reluctance components according to the present invention.

FIG. 14 shows further embodiments of arrangements of reluctance components in the moving magnet actuator.

FIG. 15 illustrates a method of manufacturing a plunger coil actuator according to the present invention.

FIG. 16 illustrates a moving magnet actuator in the prior art.

FIG. 17 illustrates other aspects of the moving magnet actuator of FIG. 16.

FIG. 18 shows a topology of a drive device and a claw clutch in the prior art.

FIG. 19 shows a prior art gear locking system.

### DETAILED DESCRIPTION

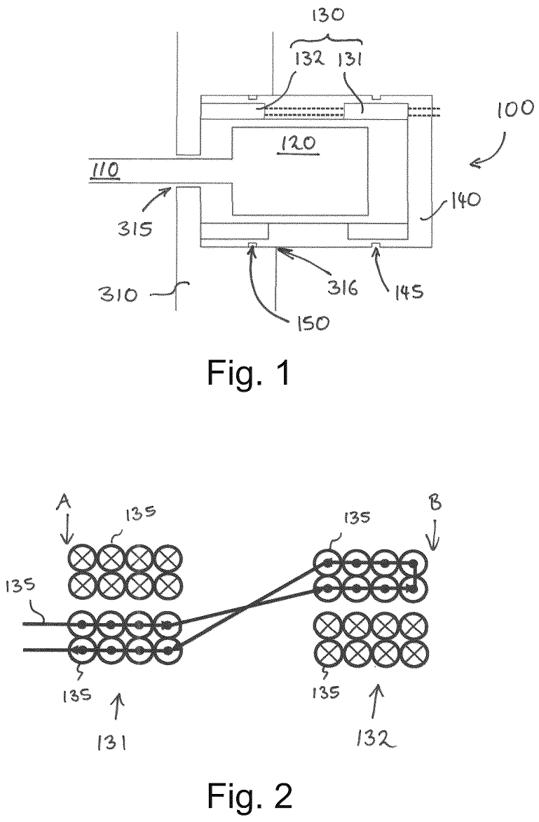

FIG. 1 illustrates a sectional view of a moving magnet actuator 100 having a plunger 110, a magnet component 120, and a coil 130 having a plurality of coil sections 131, 132 along an axis identical to an axis of the plunger 110. The coil 130 is formed by a wire that forms, from a first end of the coil 130, and successively up to a second end of the coil 130, for each coil section 131, 132 a first winding, in a winding direction associated with the respective coil section 131, 132 (see also FIG. 2). There is a change of the winding direction between a first coil section 131 and a subsequent second coil section 132. The wire forms, from the second end of the coil 130, successively and up to the first end of the coil 130, for each coil section 132, 131 a second winding in the winding direction associated with the respective coil section 131, 132. The wire thus enters and exits the first end of the coil 130.

When a current is fed to the wire, each coil section 131, 132 amplifies a force on the magnet component 120. In this embodiment, the magnet component 120 is fixedly connected to the plunger 110; in this way, a current through the coil 130 moves the plunger 110.

In this embodiment, the moving magnet actuator 100 comprises a hull 140 having a groove 145 for applying a shaft locking ring for mounting or dismounting. The moving magnet actuator 100 is mounted in a housing 310 that includes an opening 315. The plunger 110 is led through the opening 315.

In this embodiment, the moving magnet actuator 100 is mounted by an interference fit in a depressed region 316 around the opening 315 of the housing 310. The moving magnet actuator 100 includes a sealing element 150 in the form of an O-ring in a further groove of the hull 140.

FIG. 2 illustrates the winding scheme of the coil 130 in the moving magnet actuator 100 of FIG. 1. The wire 135 forms, as a first winding, an innermost layer of the first coil section 131 in a first winding direction from a first end A of the coil 130. Then, still as the first winding, the wire 135 forms an innermost layer of the second coil section 132 in a second winding direction oriented opposite the first winding direction. Subsequently, the wire 135 forms a second winding of the second coil section 132 in the second winding direction, starting from a second end B of the coil. Then, the wire 135 forms a second winding of the first coil section 131 in the first winding direction, and exits the coil 130 at the first end A.

In this embodiment, the second winding comprises one layer in each of the two coil sections 131, 132. The number of layers of each individual winding is odd in each case, but except for this limitation may be selected separately for each coil section 131, 132 and for each winding. In this way, different boundary conditions, e.g. a geometry of the moving magnet actuator 100 or a shape of the magnet component 120, can be taken into account.

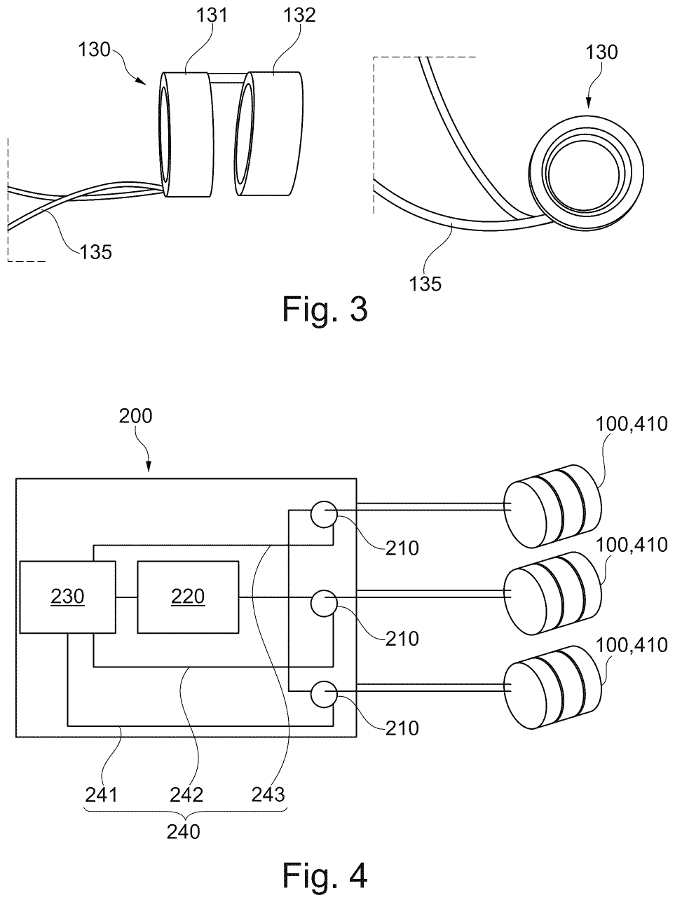

FIG. 3 shows inclusions of an embodiment of the coil 130 of the moving magnet actuator 100 of FIG. 1, wherein the winding described in FIG. 2 is present. Together with corresponding spacers made of aluminum, the coil 130 can in particular be inserted into a stator of a moving magnet actuator 100. The coil 130 may also be sealed in the stator.

FIG. 4 illustrates an embodiment of a control unit 200 for activating at least two moving magnet actuators 100, 410. In particular in drive devices with more than three gears, more than one moving magnet actuator 100, 410 usually has to be used. The moving magnet actuators 100, 410 need not necessarily have all the features of the moving magnet actuator 100 of FIG. 1.

In the embodiment shown here, the control unit 200 comprises three electronic switches 210 for a respective moving magnet actuator 100, 410. Each electronic switch 210 may have a first state and a second state. In the first state, the electronic switch 210 allows the respective moving magnet actuator 100, 410 to be activated when a current feed is applied. In the second state, the electronic switch 210 interrupts the current feed and thus the activation of the respective moving magnet actuator 100, 410. In the present embodiment, each electronic switch 210 in particular comprises a MOSFET.

The control unit 200 further comprises a bridge circuit component 220 configured to be connected to a supply voltage, and to provide a parallel current feed to the electronic switches 210 when connected to the supply voltage. In particular, the bridge circuit component 220 may be a full bridge circuit, having a bridge branch to which the electronic switches 210 and thus the moving magnet actuators 100, 410 are connected in parallel. In this embodiment, the bridge circuit component 220 is in particular connected to a drain connection of the respective electronic switch 210.

Bridge circuit components for operating moving magnet actuators are known to the person skilled in the art; however, in the embodiments of the control unit 200, instead of an individual bridge circuit component (and an individual control unit, respectively) for each moving magnet actuator 100, 410, the single bridge circuit component 220 is sufficient.

The control unit 200 further comprises an electronic control unit 230, comprising a connection component 240 having a connection 241, 242, 243 to each of the electronic switches 210. The control unit 230 may in particular be a microcontroller. The control unit 230 is configured to control the parallel current feed via the bridge circuit component 220. Furthermore, the control unit 230 is configured to individually set each of the electronic switches 210 to the open state or the closed state via the connection component 240. In particular, in this embodiment, the control unit 230 is connected to a gate terminal of each of the electronic switches 210.

For a use of the control unit 200, it is advantageous if a constant current feed to each moving magnet actuator 100 is not necessary. In the prior art, apparatuses for gear changes in electric drives are known in which shift rods 432 or shift forks 434 moved by the plunger coil actuators 100, 410 have a mechanical locking and thus ensure reliable retention in the selected shift position.

The control unit 200 offers a simplification of the circuitry of several moving magnet actuators 100, 410. Known bridge circuits have in particular four MOSFETs for controlling a moving magnet actuator 100, 410. If each of the three moving magnet actuators 100, 410 is controlled by its own control unit, each with a microcontroller and a full bridge circuit, a total of twelve MOSFETs and three microcontrollers are required. In contrast, the control unit 200 in the embodiment shown requires only seven MOSFETs and one microcontroller.

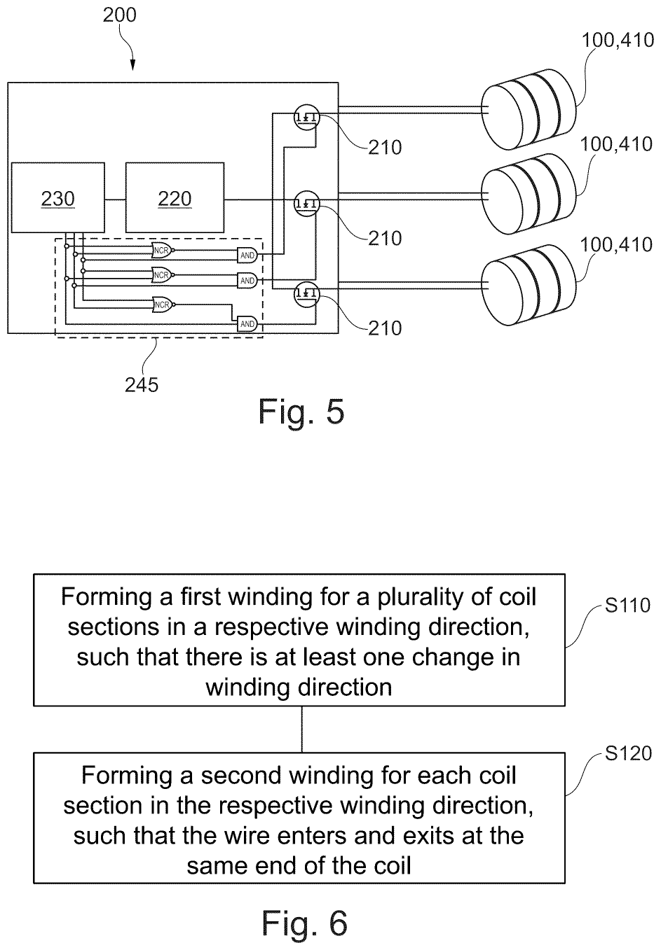

FIG. 5 illustrates an embodiment of the control unit 200 in which the connection component 240 comprises a safety circuit 245. The safety circuit 245 comprises exactly one AND gate and one NOR gate for each moving magnet actuator 100, 410, and otherwise no gates. The safety circuit 245 is configured to allow activation of at most one moving magnet actuator 100, 410 at any time.

In multi-gear vehicle drivetrains, one of the greatest hazards to vehicle occupants is simultaneous engagement of multiple gears, which usually results in drive wheels locking. Instead of a mechanical solution or a solution in a higher-level switching electronics, the control unit 200 provides protection against simultaneous actuation of two moving magnet actuators 100, 410 using the logic circuit 245 shown. The combination of a NOR and an AND gate means that only one moving magnet actuator 100, 410 can be energized at a time, regardless of any programming of the control unit 230 (e.g., software of a microcontroller). In particular, this represents a safety gain. Securing that at no time two moving magnet actuators 100, 410 are activated simultaneously is ensured at the lowest operating level, immediately before the connection to the moving magnet actuators 100, 410.

FIG. 6 illustrates steps of a method according to the present invention for winding a wire 135 into a coil 130 for a moving magnet actuator 100. The method comprises forming a first winding S110 from a first end A of the coil 130 for a plurality of coil sections 131, 132 in a winding direction associated with each coil section 131, 132, such that there is at least one change in winding direction between a first coil section 131 and a subsequent second coil section 132.

The method further comprises forming a second winding S120 from the second end B of the coil 130 for each coil section 132, 131 in the winding direction associated with the respective coil section 131, 132, such that the wire 135 exits the coil 130 at the first end A of the coil 130.

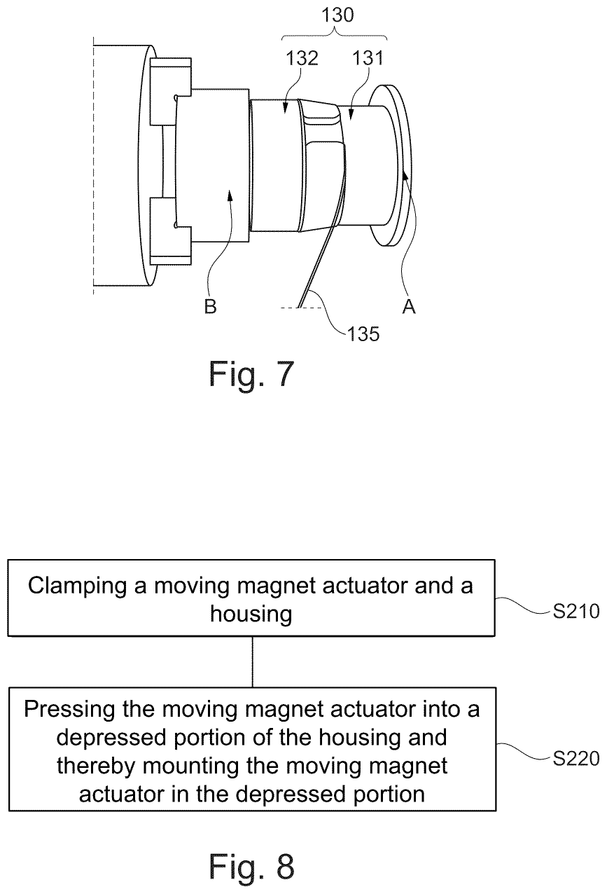

FIG. 7 shows the coil 130 according to FIG. 2 or FIG. 3 during an embodiment of the method for winding the wire 135. In particular, the figure illustrates how the change of the winding direction between a first coil section 131 and a second coil section 132 may be carried out.

The wire 135 is first wound in the first coil section 131. The wire 135 is then guided further into the second coil section 132, whereby the winding direction is reversed for the first time. There, likewise, a first winding is first carried out up to a second end B of the coil 130, and a second winding is carried out directly thereafter. Here, a winding direction of the first winding and the second winding in the second coil section 132 is opposite to a winding direction of the first winding of the first coil section 131. The wire 135 is then returned to the first coil section 131 from an end of the second coil section 132 that is close to the first coil section 131, with the winding direction reversed again. There, the wire is wound into a second winding of the first coil section 131, wherein the winding direction corresponds to that of the first winding in the first coil section 131. The wire 135 then exits the coil 130 at the first end A of the coil 130.

FIG. 8 shows steps of a method for mounting a moving magnet actuator 100, 410 in a depressed portion 316 of a housing 310 of an apparatus for changing gears of an electric drive. For this method, the moving magnet actuator 100, 410 does not necessarily require all the features of the moving magnet actuator 100 shown in FIG. 1. The method comprises clamping S210 the moving magnet actuator 100, 410 and the housing 310. The method further comprises pressing S220 the moving magnet actuator 100, 410 into the depressed portion 316 of the housing 310, by which the moving magnet actuator 100, 410 is fixed in the depressed portion 316.

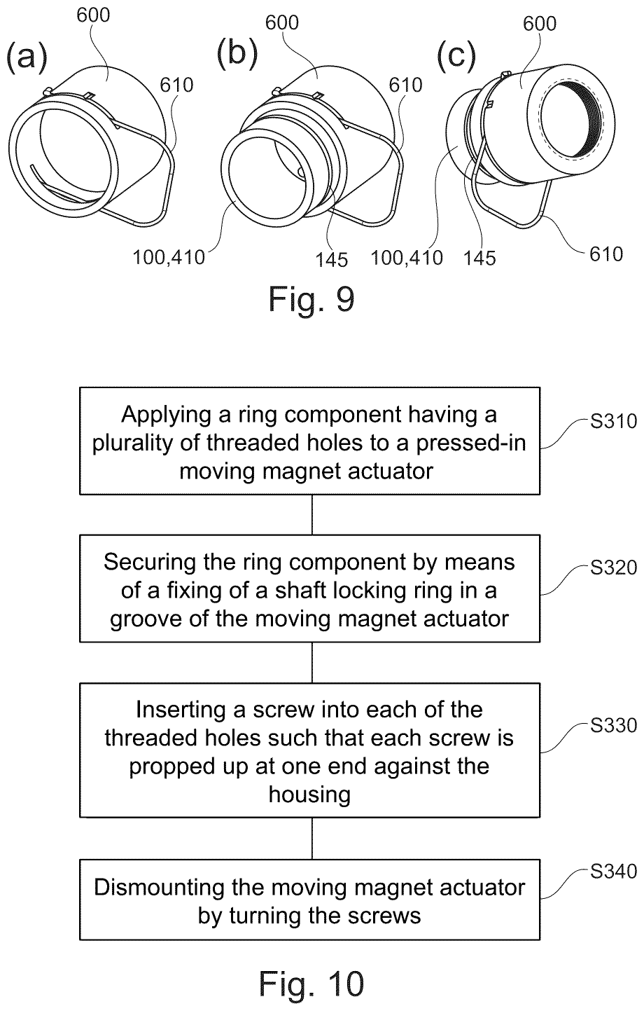

FIG. 9 illustrates an advantageous embodiment of the method for mounting a moving magnet actuator 100, 410.

In a part (a) of the figure, a mounting device 600 is shown that includes a section for a latch 610. The mounting device 600 is pot-shaped and adapted to dimensions of an outer hull of the moving magnet actuator 100, 410 in order to receive the moving magnet actuator 100, 410 or a portion of the moving magnet actuator 100, 410.

In parts (b) and (c) of the figure, two views are shown of a situation in which the mounting device 600 is applied to the moving magnet actuator 100, 410 and to a stator portion of the moving magnet actuator 100, 410, respectively. The moving magnet actuator 100, 410 comprises an outer hull with a preferably circumferential groove 145.

The clamping S210 comprises setting the moving magnet actuator 100, 410 into the mounting device 600, which is formed with the latch 610 that is engageable in the groove 145. Clamping S210 further comprises securing the moving magnet actuator 100, 410 by the latch 610 so that the moving magnet actuator 100, 410 cannot fall out. The pressing S220 comprises exerting a depressed portion of force on the mounting device 600 so as to mount the moving magnet actuator 100, 410 in a depressed portion 316 of the housing 310.

In particular, the moving magnet actuator 100, 410 is pushed into the mounting device 600 and secured against falling out by the latch 610. The latch 610 thereby engages in the groove 145; this groove 145 can also be utilized for a shaft locking ring during dismounting. The actual press-in force, which will be higher than the force that could cause the moving magnet actuator 100, 410 to fall out, is transmitted directly to the moving magnet actuator 100, 410 via the base of the mounting device 600. Once the moving magnet actuator 100, 410 has been pressed into the housing 310, the latch 610 can be loosened again by pulling, and the mounting device 600 can be lifted off the moving magnet actuator 100, 410.

The mounting device 600 can be attached to any linear pressing tools. A simple manual press my serve as an example. However, hydraulic or pneumatic presses in automated or collaborative production lines, as common in gear manufacturing, are also possible. The mounting device can also be fitted with the moving magnet actuator 100, 410 either manually or automatically, e.g. by a robot.

FIG. 10 shows steps of a method for dismounting a moving magnet actuator 100, fixed by means of an interference fit in a depressed portion (316) of a housing 310 of an apparatus for changing gears of an electric drive. The moving magnet actuator 100 does not necessarily have all the features of the moving magnet actuator 100 of FIG. 1. However, the moving magnet actuator 100 to which this method is applied comprises a cylindrical outer hull 140 having at least the circumferential groove 145 on an outer surface for applying a shaft locking ring.

The method comprises applying S310 a ring component, e.g. a steel ring, having a plurality of threaded holes to the moving magnet actuator 100. The method further comprises securing S320 the steel ring by means of a fixing of the shaft locking ring in the groove 145. The method further comprises inserting S330 a screw into each of the threaded holes such that each screw is propped up at one end against the housing 310. The method further comprises loosening S340 the moving magnet actuator 100 by screwing in the screws so as to dismount the moving magnet actuator 100 from the housing 310 by means of the steel ring and the shaft locking ring.

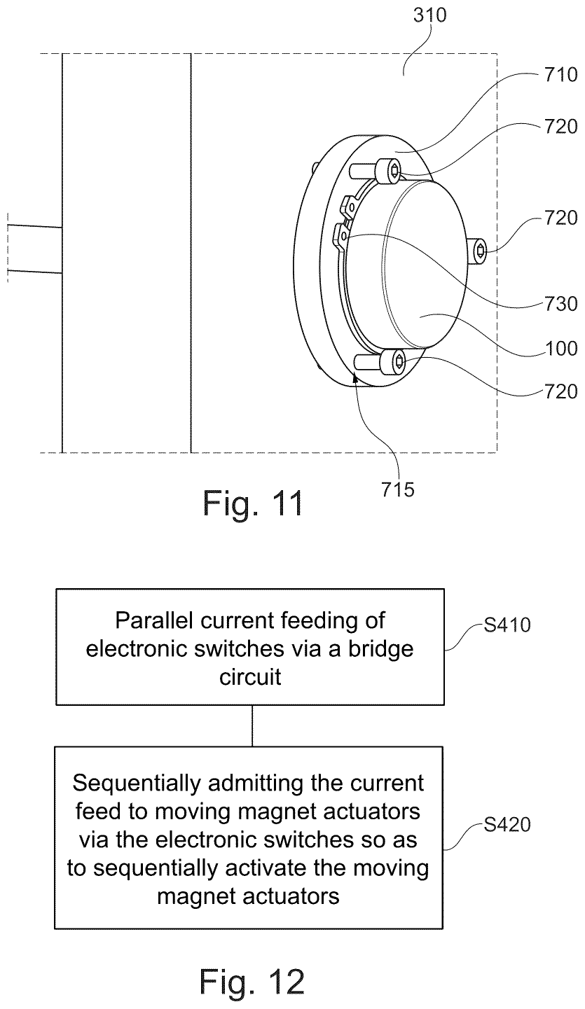

FIG. 11 illustrates the method for dismounting the moving magnet actuator 100 of FIG. 10. Shown is a portion of a housing 310 in which the moving magnet actuator 100 is pressed into a depressed portion 316 (not visible). A ring component, in this case a steel ring 710, is already applied to the moving magnet actuator 100. A shaft locking ring 730 secures the steel ring 710 by engaging the groove 145 (not visible) in the hull 140 of the moving magnet actuator 100. In this embodiment, the steel ring 710 has three threaded holes 715. Three screws 720 are threaded into the threaded holes 715 and are propped up against the housing 310. By continuing to turn the screws 720, an axial force is applied between the housing 310 and the retaining ring 710, which eventually pulls the moving magnet actuator 100 out of the housing 310. Guidance of the moving magnet actuator 100 can be added if necessary, but is already achieved at least in part by this method.

FIG. 12 shows steps of a method for sequentially activating at least two moving magnet actuators 100, 410. The moving magnet actuators need not necessarily have all the features of the moving magnet actuator of FIG. 1.

The moving magnet actuators 100, 410 are each connected to an electronic switch 210. The electronic switches 210 are configured to allow activation of the respective moving magnet actuator 100, 410 in an open state, and to prevent activation in a closed state. The electronic switches 210 may in particular each include a MOSFET.

The method comprises a parallel current feeding S410 of the electronic switches 210 via a bridge circuit. The method further comprises sequentially admitting S420 the current feed to the moving magnet actuators 100, 410 via the electronic switches 210 so as to sequentially activate the moving magnet actuators 100, 410.

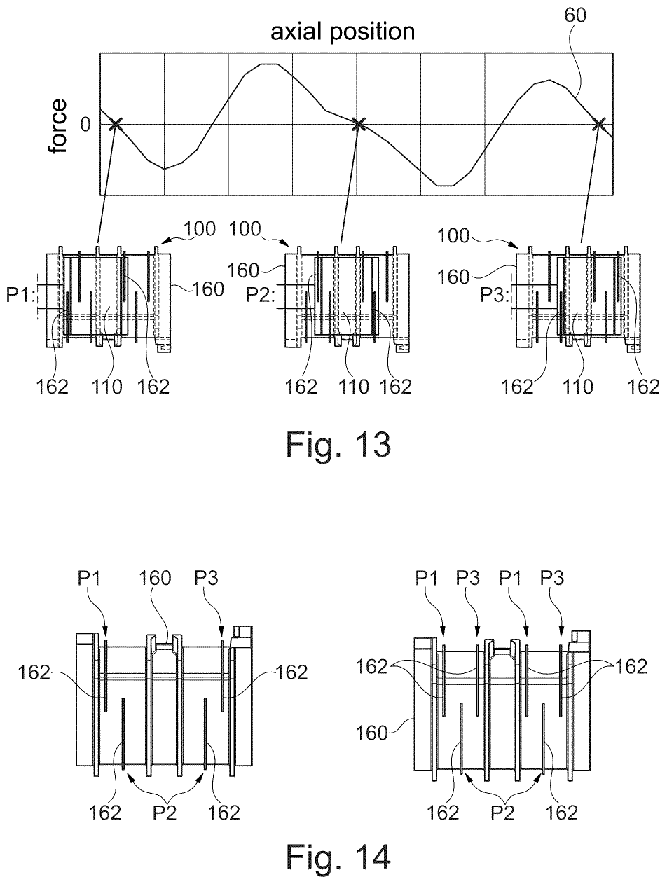

FIG. 13 illustrates a reluctance force for the case of an unpowered moving magnet actuator 100 in which a reluctance component 162, made of a ferromagnetic or ferrimagnetic material, in particular iron, and extending in a circumferential direction, is applied to a bobbin 160 at each of a plurality of axial positions.

In the illustrated embodiment, there are a total of six such reluctance components 162, as shown in a lower portion of the figure for three locking positions P1, P2, P3 of the plunger 110. The reluctance components 162 each span an angular interval of slightly more than 180° in the circumferential direction. They can also be designed as half rings. In addition, the reluctance components 162 are alternately offset by 180° in the circumferential direction on the bobbin 160. The reluctance components 162 are fixed on the bobbin 160 in corresponding grooves of the bobbin (bobbin grooves).

The reluctance components 162 result in a variation 60 of the reluctance force along an axial position, or length, of the bobbin 160 or moving magnet actuator 100. The variation 60 is shown in an upper portion of the figure. The plunger 110 is movable along an axis in two opposite directions. The force shown moves the plunger 110 in one direction for positive values, and in the other direction for negative values. At three locking positions P1, P2, P3 along the axis, the plunger 110 is held stable in each case; each of these positions thus represents a local attractive fixed point with a vanishing reluctance force. For the movable component or shift rod, the three locking positions P1. P2, P3 can correspond e.g. to positions for a first gear, a neutral position, and a second gear.

The arrangement of the reluctance components 162 shown in this figure has the particular advantage that a sum of radial forces on the plunger 110 precisely cancels, since the reluctance components 162 are installed rotated by 180°, such that the radial forces cancel each other out. Only a torque and the desired axial force are applied to the plunger 110.

FIG. 14 shows embodiments of two further arrangements of reluctance components 162 on bobbin 160.

In the embodiment shown on the left, only four reluctance components 162 are applied at four different axial positions. Each of the reluctance components 162 again spans about 180° of the angle in the circumferential direction. Again, the reluctance components 162 form pairs whose partners are mounted offset from each other by 180°. However, in contrast to the embodiment example of FIG. 13, the offset is not in strictly alternating order along the axis. In the embodiment shown here, however, there are also three locking positions P1, P2, P3, wherein the reluctance components 162 which effect the corresponding locking position are designated in the figure. The locking positions P1, P2, P3 may again correspond to a first gear, a neutral position and a second gear.

Similarly to the embodiment in FIG. 13, the embodiment shown on the right has six reluctance components 162. In this embodiment, the reluctance components 162 are however not applied with a strictly alternating 180° offset in the axial direction. Again, this results in three locking positions P1, P2, P3, wherein the reluctance components 162 responsible in each case are marked in the figure. The first gear (locking position P1) and the second gear (locking position P3) result from the upper reluctance components 162, and the neutral position (locking position P2) from the lower reluctance components 162.

Due to the arrangements of the reluctance components 162 shown in this figure, the plunger 110 experiences a radial force in each of the locking positions P1, P2, P3. This can be advantageous because the radial force can push the plunger 110 in a particular direction against the bobbin 160, providing additional static friction.

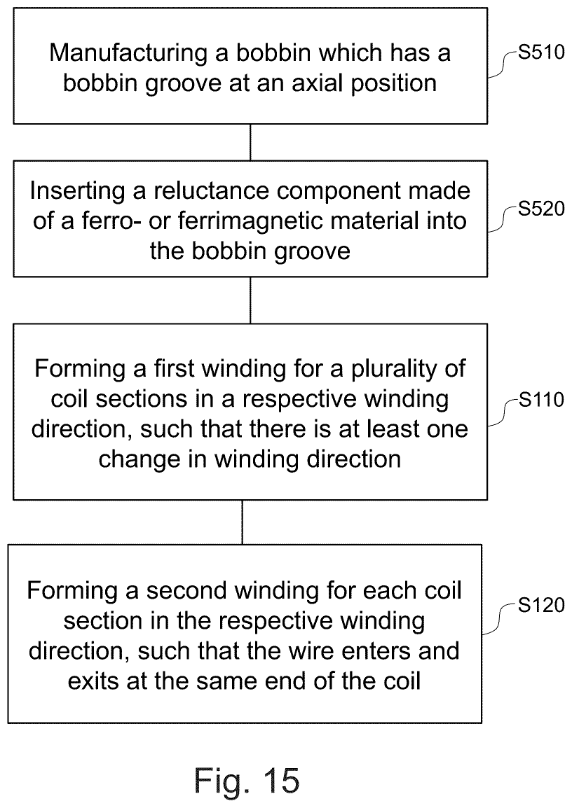

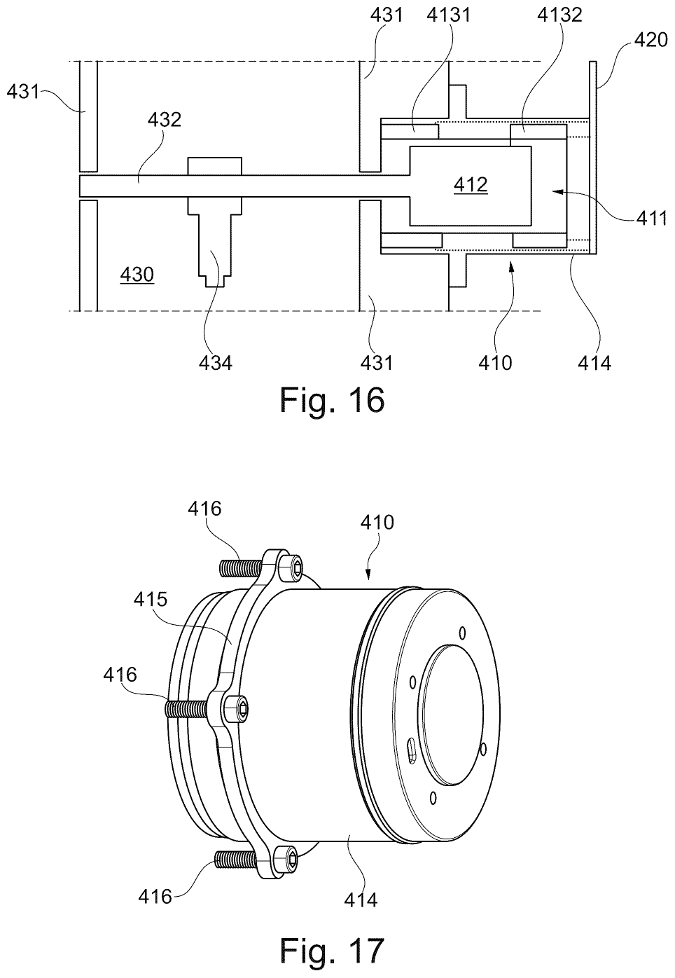

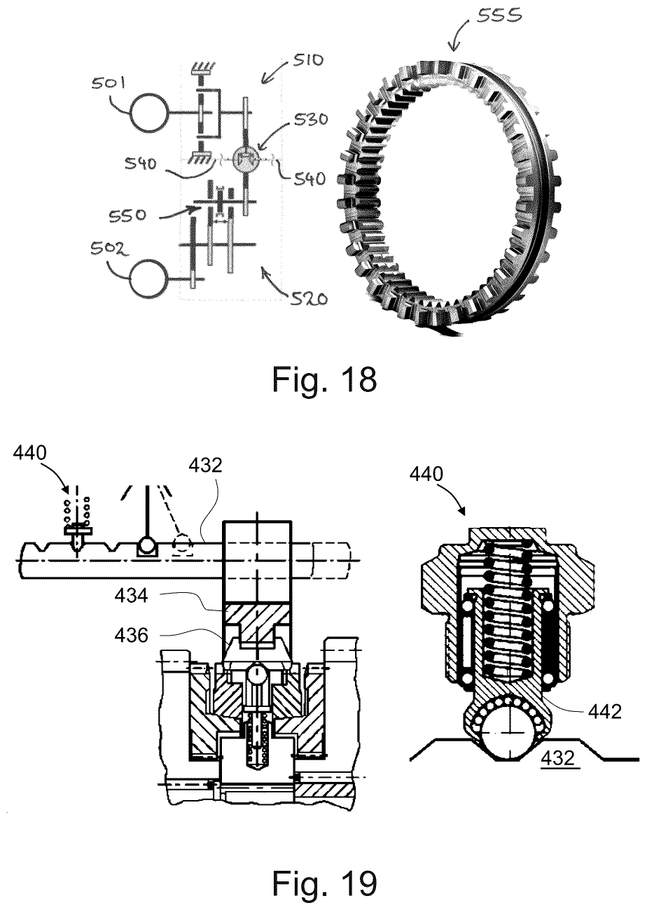

FIG. 15 illustrates an embodiment of the manufacturing process for a moving magnet actuator 100. First, a manufacturing S510 of the bobbin 160, which has a plurality of bobbin grooves 165 at specific axial positions, is performed. This is followed by inserting S520 reluctance components 162, in this case essentially semicircular ring elements (spanning 180° or slightly more in circumferential direction) made of iron, into the bobbin grooves 165. The reluctance components 162 are axially positioned by the bobbin grooves 165 and held in place by their clamping device to prevent their loss. Subsequently, the coil 130 is manufactured, e.g. by fully automatically performed winding S110, S120 according to the method shown in FIG. 6.

The features of the invention disclosed in the description, the claims and the figures may be essential to the realization of the invention either individually or in any combination.

### LIST OF REFERENCE SIGNS

60 variation of a force
100 moving magnet actuator
110 plunger
120 magnet component
130 coil
131, 132 coil sections
135 wire
140 hull
145 groove
150 sealing element
160 bobbin
162 reluctance component
165 bobbin groove
200 control unit
210 electronic switch
220 bridge circuit component
230 electronic control unit
240 connection component
241, 242, 243 connections
245 safety circuit
300 apparatus for changing gears of an electric drive
310 housing
315 opening
316 depressed portion
410 conventional moving magnet actuator
411 plunger
412 permanent magnet
4131, 4132 coils
414 hull
415 flange for screws
416 screws
420 conventional control unit
430 apparatus for changing gears
431 housing
432 shift rod
434 shift fork
440 locking mechanism
442 ball spring unit
501, 502 electric motors
510, 520 sub-transmission
530 differential gear
540 wheel axles
550 shifting mechanism
555 claw coupling
600 mounting device
610 latch
710 steel ring
715 threaded holes
720 screws
730 shaft locking ring
A, B ends of a coil
P1, P2, P3 locking positions
S110, S120 steps of a method for winding a wire for a moving magnet actuator
S210, S220 steps of a method for mounting a moving magnet actuator
S310, S320, S330, S340 steps of a method for dismounting a moving magnet actuator
S410, S420 steps of a method for sequentially activating multiple moving magnet actuators
S510, S520 steps of a method for manufacturing a moving magnet actuator

1. A gearshift for an electric drive, the gearshift comprising:
a housing having a depressed portion with an opening through which a movable component is led; and
at least one moving magnet actuator configured to move the component and mounted in the depressed portion.

2. The gearshift according to claim 1, wherein the moving magnet actuator comprises:
a plunger having a magnet component mounted thereon; and
a coil wound around a bobbin,
wherein a reluctance component of a ferromagnetic or ferrimagnetic material extending in a circumferential direction is applied to the bobbin at an axial position, which exerts a reluctance force on the magnet component for locking the plunger at an axial locking position.

3. The gearshift according to claim 2, wherein a further reluctance component of the ferromagnetic or ferrimagnetic material is applied to the bobbin at at least one further axial position, and wherein the reluctance component and the further reluctance component each extend at least through an angle of 180° in the circumferential direction and are arranged offset from each other by 180° in the circumferential direction in order to cancel a radial force on the magnet component.

4. The gearshift according to claim 2, wherein the reluctance component and/or the further reluctance component is/are each fitted into a bobbin groove.

5. The gearshift according to claim 1, wherein the moving magnet actuator comprises an outer hull having at least one of the following features on an outer surface:
a circumferential groove for applying a shaft locking ring,
a circumferential sealing element, and
a common input and output for a wire for a current feed to the coil.

6. The gearshift according to claim 1, comprising at least one further moving magnet actuator, wherein a control unit is configured to activate at least two moving magnet actuators, the control unit comprising:
for each moving magnet actuator an electronic switch for activating and deactivating the respective moving magnet actuator;
a bridge circuit component configured to be connected to a supply voltage and to provide a parallel current feed to the electronic switches when connected to the supply voltage; and
an electronic control unit comprising a connection component having a connection to each of the electronic switches and configured to control the parallel current feed via the bridge circuit component and to individually activate or deactivate each of the at least two moving magnet actuators via the connection component and the electronic switches.

7. The gearshift according to claim 6, wherein the connection component comprises a safety circuit having exactly one AND gate and one NOR gate for each moving magnet actuator and otherwise no gates, and is configured to allow activation of at most one moving magnet actuator at any time.

8. The gearshift according to claim 1, wherein the moving magnet actuator comprises:
a plunger,
a magnet component and
a coil having a plurality of coil sections along an axis, wherein upon current feed to the coil, each coil section amplifies a force on the magnet component to linearly move the plunger;
wherein the coil is formed by a wire,
wherein the wire, starting from a first end of the coil, successively forms for each coil section a first winding in a winding direction associated with a respective coil section,
so that there is at least one change of the winding direction, and
wherein the wire, starting from a second end of the coil, successively forms for each coil section a second winding in the winding direction associated with the respective coil section
and exits the coil at the first end of the coil.

9. The gearshift according to claim 8, wherein the magnet component is fixedly connected to the plunger.

10. The gearshift according to claim 1, wherein the component is a plunger of the moving magnet actuator.

11. A method comprising the steps of:
clamping of a moving magnet actuator and of a housing; and
pressing the moving magnet actuator into a depressed portion of the housing, thereby mounting the moving magnet actuator in the depressed portion.

12. The method according to claim 11, wherein the moving magnet actuator comprises an outer hull having a circumferential groove for application of a shaft locking ring,
wherein the clamping comprises the following steps:
setting the moving magnet actuator in a mounting device formed with a latch that engages the circumferential groove; and
securing the moving magnet actuator with the latch,
and wherein the pressing comprises the following step:
exerting a press-in force on the mounting device so as to mount the moving magnet actuator in the depressed portion.

13. The method according to claim 11, wherein the moving magnet actuator comprises an outer hull having a circumferential groove on an outer side for applying a shaft locking ring, and the method further comprises the steps of:
applying a ring component having a plurality of threaded holes to the moving magnet actuator;
securing the ring component on the moving magnet actuator by fixing the shaft locking ring in the groove;
inserting a screw into each of the threaded holes so that each screw is propped against the housing at one end; and
loosening the moving magnet actuator by turning the screws in order to dismount the moving magnet actuator from the housing by means of the shaft locking ring.

14. A method of sequentially activating at least two moving magnet actuators, wherein the moving magnet actuators each include an electronic switch, and the electronic switches are configured to activate and deactivate the respective moving magnet actuator, the method comprising the steps of:
parallel current feeding of the electronic switches via a bridge circuit; and
sequentially admitting the current feed to the moving magnet actuators via the electronic switches in order to sequentially activate the moving magnet actuators.

15. (canceled)

16. A method of manufacturing a moving magnet actuator comprising:
manufacturing a bobbin with a bobbin groove at an axial position;
fitting a reluctance component of a ferromagnetic or ferrimagnetic material into the bobbin groove, wherein the reluctance component, after the fitting, extends in a circumferential direction with respect to the bobbin.

17. (canceled)

18. The method of claim 16, further comprising the steps of:
forming a first winding starting from a first end of the coil, for a plurality of coil sections in a winding direction associated with each coil section, such that there is at least one change in winding direction between a first coil section and a subsequent coil section;
forming a second winding, starting from the second end of the coil, for each coil section in the winding direction associated with the respective coil section so that the wire exits the coil at the first end of the coil.
